(19) United States
(12) Patent Application Publication
(10) Pub. No.: US 2010/0088459 A1
(43) Pub. Date: Apr. 8, 2010

(54) Improved Hybrid Drive

(76) Inventors: Siamak Arya, Cupertino, CA (US); Fong-Long Lin, Fremont, CA (US)

Correspondence Address: DLA PIPER LLP (US ), 2000 UNIVERSITY AVENUE, EAST PALO ALTO, CA, 94303-2248, US

(21) Appl. No.: 12/246,327

(22) Filed: Oct. 6, 2008

(51) Int. Cl. G06F 12/02

(52) U.S. Cl. 711/103; 711/E12.008

(57) ABSTRACT

A non-volatile storage system comprises a hard disk drive (HDD) having a first capacity for storing information therein in a plurality of blocks. The storage system also comprises a non-volatile solid state memory (SSD) having a second capacity, less than the first capacity, for storing information therein. Finally, the storage system comprises a controller having a volatile memory and for controlling the read operation of the HDD and the read/write operation of the SSD. The controller stores in the volatile memory the address of read blocks from the HDD in a first period of time and determines a plurality of the most frequently read blocks in the first period of time, The controller then causes the SSD to store information from the most frequently read blocks from the HDD, and thereafter causes information to be read from the SSD when the storage system is requested to access information from the most frequently read blocks. The controller resets the identity of the most frequently read blocks in the volatile memory after a second period of time, where the second period of time is longer than said first period of time.

### TECHNICAL FIELD

The present invention relates to an improved storage device that comprises a hard disc drive and a non-volatile memory cache.

### BACKGROUND OF THE INVENTION

Hybrid drives are well known in the art. A hybrid drive comprises a hard disk drive (HDD) with a solid state drive (SSD) used as a cache memory. The lure of a hybrid drive is that data or program that are frequently accessed from the HDD are stored in the non-volatile memory of the SSD with the SSD acting as a cache for the HDD. As a result, in theory, a hybrid drive is supposed to increase performance, reduce access time, and reduce power. However, hybrid drives have not lived up to their promise for a number of reasons.

Typically, in the prior art, the hybrid drive operates much as a conventional cache memory does. Initially, when a block of data is retrieved or read from the HDD, it is also stored in the SSD. If a subsequent read request is to the same block, then the data from the SSD is read. However, if the subsequent read request is to a different block, then the data from the different block is read and is simultaneously stored in the SSD. Once the SSD is filled up and a subsequent read request to the HDD is made, then typically, the data read from the most recent request to the HDD is stored in a location in the SSD, replacing the block of data in the SSD that is the oldest in time in being accessed. This theory is that if a block of data in the SSD has not been accessed the longest period of time, then it should be replaced.

In some hybrid drives, a portion of the memory of the SSD is dedicated to store operating system programs or the like which are always used and can never be replaced no matter how infrequently they are used.

Nevertheless, hybrid drives have not lived up to their expectation because frequently used programs and data have not been found in the SSD often enough. In part this is caused by the expense of the non-volatile memory used in the SSD. Hence the amount of total memory used in the SSD has been small. Furthermore, conventional methods for optimized use of the SSD has relied upon the SSD being a static memory cache for the HDD.

Hence there is a need to improve the performance of hybrid drives.

### SUMMARY OF THE INVENTION

Accordingly, in the present invention, a non-volatile storage system comprises a hard disk drive (HDD) having a first capacity for storing information therein in a plurality of blocks. The storage system also comprises a non-volatile solid state memory (SSD) having a second capacity, less than the first capacity, for storing information therein. Finally, the storage system comprises a controller having a volatile memory and for controlling the read operation of the HDD and the read/write operation of the SSD. The controller stores in the volatile memory the address of read blocks from the HDD in a first period of time and determines a plurality of the most frequently read blocks in the first period of time. The controller then causes the SSD to store information from the most frequently read blocks from the HDD, and thereafter causes information to be read from the SSD when the storage system is requested to access information from the most frequently read blocks. The controller resets the identity of the most frequently read blocks in the volatile memory after a second period of time, where the second period of time is longer than said first period of time.

The present invention also relates to a method of reading data stored in the foregoing described non-volatile storage system.

### BRIEF DESCRIPTION OF THE DRAWINGS

FIG. 1 is a block level diagram of the improved storage system of the present invention.

FIG. 2 is a schematic diagram of one embodiment of the buffers used in the controller shown in FIG. 1.

### DETAILED DESCRIPTION OF THE INVENTION

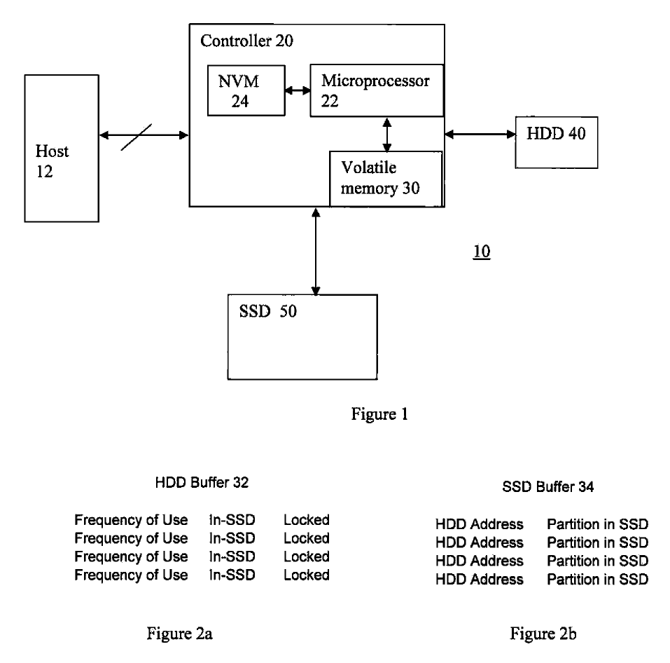

Referring to FIG. 1 there is shown a block level diagram of an improved non-volatile storage system 10 of the present invention. The system comprises a controller 20 connected to the host device 12. The host device 12 typically is a processor or a computer. The controller 20 comprises a volatile memory 30, a microprocessor 22, and a non-volatile memory (NVM) 24. The NVM 24 stores a program for execution by the microprocessor 22. Of course, the stored program stored in the NVM 24 can also be updated by the host device 12. The microprocessor 22 receives the stored program from the NVM 24 and executes the instructions there on and controls the volatile memory 30. In addition, the controller is connected to a hard disc drive (HDD) 40. Finally, the system 10 comprises a solid state drive (SSD) 50, which is also connected to the controller 20 and is under the control of the controller 20. The microprocessor 22 in executing the stored program from the NVM 24 also controls the operation of the HDD 40 and the SSD 50 and the nonvolatile memory 30 in accordance with the invention described hereinafter.

The HDD 40 is a conventional disc drive, while the SSD 50 is also a conventional solid state drive, comprised of non-volatile solid state memory integrated circuit chips.

In the operation of the system 10, the volatile memory 30 is “reset” when power is turned on, since by definition a volatile memory 30 “loses” all contents stored therein when power is removed. Initially, when the host 12 requests a read operation to the system 10, the controller reads the HDD 40 and retrieves the data therefrom. The HDD 40 may be partitioned by the controller 20 in to a plurality of blocks. The particular data requested by the host 12 is read from one of the blocks. The address of the block where the read data is requested by the host 12 is then stored in the volatile memory 30. Associated with the address of the block where the read data is requested is also a counter signifying the number of times that block of data is read from the HDD 40.

This process for retrieving data from the HDD 40 (as each new read request is issued by the host 12) and recording in the volatile memory the frequency that a particular block has been accessed is continued for a first period of time, N. Once the first period of time, N is past, the controller 20 determines from volatile memory 30, the list of blocks that have been accessed during that first period of time, N. The controller 20 selects or determines the list of blocks that have been most frequently accessed from the HDD 40 such that the data from those most frequently access blocks can be stored in the SSD 50. Of course, a portion of the SSD 50 may contain operating programs and the like which remain statically stored in the SSD 50 irrespective of the method of the present invention, so that those programs which are used for boot-up purpose may cause rapid boot up by being accessed from the SSD 50 rather than the HDD 40.

Once the most frequently read or accessed blocks are identified, then the data from the HDD 40 from those most frequently accessed blocks are stored in the SSD 50. This can be done in one of two ways. First as each read request is made by the host 12 to the system 10 for a read operation for data from the most frequently accessed blocks from the HDD 40, the data is read from that block and is stored in the SSD 50 as the data from that block is also supplied to the host 12. Second, in lieu of or in addition to the first way, the system 10 can read the blocks of most frequently accessed blocks from the HDD 40 and store them in the SSD 50 when the system 10 is idle and is not receiving any commands or request (read or write) from the host 12. In this manner, the system 10 can be used for this storage operation without interfering with any of the requests from the host 12.

Once the data from the most frequently accessed blocks are stored in the SSD 50, then as each new read request from the host 12 is received by the system 10, the controller 20 first checks the volatile memory 30 to determine if the data is in the SSD 50. In the event the data is in the SSD 50, then the data from the SSD 50 is read. However, if the data is not from one of the most frequently accessed blocks, then the data is read from the HDD 40. In either case, the frequency of use counter in the volatile memory 30 is incremented each time a block of data is read from the HDD 40 or from the SSD 50. If the host 12 writes data to one of the most frequently accessed blocks, then the new block of data is also re-written into the SSD 50, as well as the HDD 40. This continues for a second period of time, N.

At the end of the second period of time, N, the controller 20 re-examines the values stored in the frequency of use counters in the volatile memory 30. The controller 20 would again determine from the volatile memory 30, the list of blocks that have been most frequently accessed from the HDD 40 such that the data from those most frequently access blocks can be stored in the SSD 50. since it is likely that some of the data to be stored in the SSD 50 are already stored in the SSD 50 from the first period of time, N, the blocks that are frequently accessed change little if any from the blocks that were most frequently accessed during the first period of time, N. Thus, after the second period N, the time required to stored the data from the most frequently accessed blocks is less than when the SSD 40 was initially stored after the first period N.

This operation of repeatedly checking the frequently accessed blocks after each period of time N is repeated, until a total period of M has past. In general, with a period of time M (such as twenty four hours) there may be a multiple number of N periods (each N being one hour), in which the SSD 50 is updated by the frequency of use counters in the volatile memory 30. At the end of the M period of time, however, all the frequency of use counters in the volatile memory are reset.

Referring to FIGS. 2a and 2b, there is shown a schematic diagram of one embodiment of the volatile memory 30 used in the controller 20 shown in FIG. 1. The volatile memory 30 comprises two buffers: a first buffer 32, shown in FIG. 2a and a second buffer 34 shown in FIG. 2b. The first buffer 32 is also called the HDD buffer 32. The second buffer 34 is called the SSD buffer 34.

Assume that the HDD 40 has a total storage capacity of 128 GBytes. Assume further that each block of data is 128 Kbytes. Thus, there are 1 mega different blocks in the HDD 40, each representing a block of data of 128 K bytes. The HDD Buffer 32 has a storage capacity of 2 Mbytes, i.e. 1 million entries, each with 2 bytes or 16 bits. For each entry that corresponds to one block, the HDD buffer 32 has 14 bits to keep count of the frequency of access for that block during the first period of time N. Further each block has an entry (1 bit) (called “In-SSD” bit) to indicate whether that corresponding entry is in the SSD Buffer 34. In the event the bit is set, then it indicates that HDD entry is also stored in the SSD Buffer 34. Finally, each block has an entry (1 bit) (called “Locked” bit) to indicate whether that block is locked. In the event the bit is set, then it indicates that block of data is in the SSD 50 and is locked and cannot be removed or replaced with a frequently accessed block.

If each block is 128 Kbytes, and if we assume that the SSD 50 has a total storage capacity of 4 Gbytes, then a total of 8K different blocks (each of 128 K Bytes) can be stored in the SSD 50. Thus, the SSD buffer 34 has 8K entries, one for each of the different blocks that can be stored in the SSD 50. For each entry in the SSD 50, twenty (20) bits are reserved for the address in the HDD 40 that the block corresponds to. Further, one (1) bit is reserved for the entry “Partition in SSD”, which indicates whether the data corresponding to the HDD Address is stored in the SSD 50.

In the operation of the system 10 with the volatile memory buffers 32 and 34 described hereinabove, upon power up, the memories 32 and 34 are all blank. Let's assume that also the SSD 50 is blank. Thus, the flag for “In-SSD” in each of the block entries in the HDD buffer 32 is blank indicating that the data is not stored in the SSD Buffer 34. Further, the “Locked” bit corresponding to each block entry is also not set. As each entry in a block of the HDD 40 is accessed, the “Frequency of Use” field in the corresponding block entry in the HDD Buffer 32 is incremented. Then after a first period of time, N, such as sixty (60) minutes, many of the entries in the HDD Buffer 32 are checked to determine the 8K entries having the highest or largest count in the “Frequency of Use” field. Then as previously discussed, either during a subsequent read to those block entries from the HDD 40 in which the data from those read blocks are copied into the SSD 50, or when the system 10 is idle and is not servicing any request from the host 12, blocks of data from the 8K entries with the highest or largest “Frequency of Use” are read from the HDD 40 and then copied into the SSD 50. In either event, as a block of data is read from the HDD 40 and copied into the SSD 50, the flag “In-SSD” in the HDD Buffer 32 corresponding to the read block from the HDD 40 is then set. The particular HDD address from where the block is read is then stored in one of the 8K entries in the SSD Buffer 34 in the field “HDD Address” The flag “Partition in SSD” is then also set to indicate that the data is in the SSD 50. This continues until all 8K entries are copied from the HDD 40 to the SSD 50.

During the copying process, or after all 8K entries are copied, as a read request is received by the system 10 from the host 12, the HDD Address from where the host 12 requests the block to be read is compared to the HDD Address stored in the SSD Buffer 34. If the particular HDD Address requested by the host 12 matches one of the entries in the SSD Buffer 34 in the field “HDD Address”, then the data is read from the corresponding entry in the SSD 50. If the particular HDD Address requested by the host 12 does not match any of the entries in the SSD Buffer 34 in the field “HDD Address”, then the data is read from the HDD 40. This continues for a second period of N, which is another sixty (60) minutes. As previously discussed, during the second period of time, N, the frequency of use counter in the HDD Buffer 32 continues to be updated. Finally after a period of time of M, which can be twenty-four (24) hours, the frequency of use counters in the HDD Buffer 32 are reset. Of course, the values of N and M may be dynamically modified.

After the period of time of M, the field “Frequency of Use” in all one (1) mega entries in the HDD Buffer 32 are re-set to zero. Then the process of accessing the HDD 40 to read for a first period of time, N, is repeated. Further, as each block from the HDD 40 is accessed as discussed previously, the “Frequency of Use” in the HDD Buffer 32 is incremented.

After the second period of N has passed, the Frequency of Use filed in the HDD buffer 32 is sorted, as discussed heretofore. Once again the 8K entries having the highest blocks are selected. The controller 20 then checks to see if the HDD Address for the selected 8K entries are also present in the SSD Buffer 34. If the HDD Address for the selected entry is in the SSD Buffer 34, then nothing is done. If however, the HDD Address for the selected block entry is not in the SSD Buffer 34, then the flag “In-SSD” for that HDD Address in the SSD Buffer 34 is set to indicate that the HDD Address is not in the SSD Buffer 34. In addition, the SSD Buffer 34 is examined, and all of the entries for HDD Address which are not selected are then removed from the SSD Buffer 34. All other entries in the HDD Buffer 32 which are part of the 8K selected entries, and which are not already in the SSD Buffer 34, are then copied into a free entry in the SSD Buffer 34. The corresponding flag for those copied entries for “In-SSD” is set to indicate the field is in the SSD buffer 34. The flag “Partition in SSD” for that HDD Address however is not set until the data for that HDD address is copied and stored in the SSD 50.

Thereafter, as each read operation occurs, the HDD Address from the host 12 is compared to the HDD address stored in the SSD Buffer 34. If the address does not match, then it indicates that the requested address is not one of the 8K entries, and the data is read directly from the HDD 40. However, if the address does match, then the flag “Partition in SSD” is checked. If the flag is valid, then the data is read from the SSD memory 50. However, if the flag is invalid, then again, the read request is made to the HDD 40, where the data for that block is read, and supplied to the host 12. At the same time, that data is stored in the SSD memory 50 and the flag for “Partition in SSD” is then set to valid, indicating that a subsequent read can be made from the SSD memory 50.

To maintain data coherence and consistency, during any write operation to the HDD 40, any write operation into the HDD 40, at a certain block address, would also cause the same data to be written into the SSD 50, if the data for that same block address is also stored in the SSD 50.

One benefit of the method and device of the present invention can be seen by the following example. The system 10 along with the host 12 is a PC system. On the first day of operation a user may be using the PC for document creation, using text editing program and storing text files. These programs and data would be most frequently used, during that session. Thus, the SSD 50 would store that program and data for a most efficient read in response to the host 12. On a second day, the PC may be used for spread sheet analysis. The spread sheet program and associated files would be stored in the SSD 50 for that operation. Thus, as the use changes, the data/program stored in the SSD 50 would change to optimize the read operation from the system 10.

It should be clear to one of ordinary skill in the art that there are many variations of the present invention. First, the partition in the SSD 50 may be a multi-bit field, where each bit corresponds to the smallest unit of transfer. For example, for a storage device that access 4 KB of data at a time, with a 128 KB partition, there may be 32 pages which will be accessed and transferred at a time. Thus, making this field 32 bits will allow marking every page that is transferred. Further, one does not have to transfer all of 128 KB of the block at once, especially if the user is requesting 4 KB at a time. Therefore, every time a page is transferred the corresponding bit in that field for the block transferred is marked.

Secondly, the buffers HDD 32 and SSD 34 may be combined into a single buffer which will have the address of the block in SSD 50 in the corresponding field of the HDD buffer 32 with partition in the SSD field. This will create a more efficient look up for the requested HDD block in the SSD 50. However, this requires a buffer page larger than the two buffers 32 and 34.

What is claimed is:

1. A non-volatile storage system comprising:
a hard disk drive (HDD) having a first capacity for storing information therein in a plurality of blocks;
a non-volatile solid state memory (SSD) having a second capacity, less than the first capacity, for storing information therein; and
a controller having a volatile memory and for controlling the read operation of the HDD and the read/write operation of the SSD wherein said controller for storing in said volatile memory the address of blocks read from said HDD in a first period of time; for determining a plurality of the most frequently read blocks in said first period of time; for storing in said SSD said information from said most frequently read blocks from said HDD; for reading thereafter information from said SSD when said non-volatile storage system is requested to access information from said most frequently read blocks; and for resetting the identity of the most frequently read blocks in said volatile memory after a second period of time, wherein said second period of time is longer than said first period of time.

2. The non-volatile storage system of claim 1 wherein said identity of most frequently read blocks in said volatile memory is reset after every power up.

3. The non-volatile storage system of claim 1 wherein said second period of time comprises a plurality of first period of time.

4. The non-volatile storage system of claim 3 wherein said controller determines a plurality of the most frequently read blocks from said HDD after each first period of time.

5. A method of reading data stored in a non-volatile storage system, wherein said non-volatile storage system having a hard disk drive (HDD) having a first capacity for storing data therein in a plurality of blocks, a non-volatile solid state memory (SSD) having a second capacity, less than the first capacity, for storing data therein; and a controller having a volatile memory, for controlling the read operation of the HDD and the read/write operation of the SSD; said method comprising:
reading data from blocks from said HDD for a first period of time;
storing in said volatile memory the address of read blocks from said HDD;
determining a plurality of the most frequently read blocks in said first period of time;
storing in said SSD said data from said most frequently read blocks from said HDD;
reading data from said SSD when said non-volatile storage system is requested to access information from said most frequently read blocks; and
resetting the identity of the most frequently read blocks in said volatile memory after a second period of time, wherein said second period of time is longer than said first period of time.

6. The method of claim 5 wherein said step of storing in said SSD said data from said most frequently read blocks from said HDD is accomplished by storing in said SSD said data from said most frequently read blocks from said HDD as said data is requested from said non-volatile storage system, and is read from said HDD.

7. The method of claim 5 wherein said step of storing in said SSD said data from said most frequently read blocks from said HDD is accomplished by storing in said SSD said data from said most frequently read blocks from said HDD when there is no request to said non-volatile storage system.

8. The method of claim 5 wherein said second period of time comprises a plurality of said first period of time.

9. The method of claim 8 wherein associated with each of the address of the read blocks from said HDD stored in said volatile memory is a counter, wherein each counter is incremented after a read operation to the associated address from said HDD is completed.

10. The method of claim 9 wherein said reset step resets each of said counters after said second period of time.

11. The method of claim 10 wherein said determining step determines the frequency of the read blocks after each said first period of time, based upon the counters in said volatile memory.

12. A controller for controlling the operation of a hard disk drive (HDD) and a non-volatile solid state memory (SSD); said controller comprising:
a volatile memory;
a non-volatile memory for storing a stored program; and
a microprocessor for executing the stored program for controlling the read Operation of the HDD and the read/write operation of the SSD wherein said microprocessor for storing in said volatile memory the address of blocks read from said HDD in a first period of time; for determining a plurality of the most frequently read blocks in said first period of time; for storing in said SSD said information from said most frequently read blocks from said HDD; for reading thereafter information from said SSD when said non-volatile storage system is requested to access information from said most frequently read blocks; and for resetting the identity of the most frequently read blocks in said volatile memory after a second period of time, wherein said second period of time is longer than said first period of time.

13. The controller of claim 12 wherein said microprocessor for executing the stored program for resetting said identity of most frequently read blocks in said volatile memory after every power up.

14. The controller of claim 12 wherein said second period of time comprises a plurality of first period of time.

15. The controller of claim 13 wherein said microprocessor for executing said stored program for determining a plurality of the most frequently read blocks from said HDD after each first period of time.
